(19) United States
(12) Patent Application Publication
(10) Pub. No.: US 2015/0034580 A1
(43) Pub. Date: Feb. 5, 2015

(54) Modular Storage in Passenger Compartments

(71) Applicant: Henrik Hofvander, Denver, CO (US)

(72) Inventor: Henrik Hofvander, Denver, CO (US)

(21) Appl. No.: 14/447,411

(22) Filed: Jul. 30, 2014

Related U.S. Application Data
(60) Provisional application No. 61/859,925, filed on Jul. 30, 2013.

(51) Int. Cl. B60R 7/04; B60R 11/00

(52) U.S. Cl. CPC B60R 7/04; B60R 11/00; B60R 2011/0003
USPC 211/87.01

(57) ABSTRACT

A modular storage system includes at least two vertical rails having a first rail and a second rail, one or more first adapter configured to attach at least the first rail to one or more mounting point on a rear wall of a vehicle in a vertical orientation, wherein the one or more mounting point is a pre-existing structure for attachment to the frame or body of the vehicle, at least one storage organizer, and at least one interface piece attaching the storage organizer to at least one of the at least two vertical rails.

### CROSS-REFERENCES TO RELATED APPLICATIONS

This application claims priority to U.S. Patent Application Ser. No. 61/859,925, filed on Jul. 30, 2013 by Henrik Hofvander (attorney docket no. 0609.01PR), entitled, “Modular Storage System for Vehicles,” the disclosure of which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF INVENTION

The present invention relates to modular storage systems, in particular modular storage systems that can be installed in the rear compartment of extended cab and crew cab, type passenger vehicles such as pickup trucks.

### BACKGROUND

When transporting equipment, supplies, other gear and items in pickup trucks or other passenger vehicles, the items can be too fragile or delicate to transport in the truck bed, or a trunk. Oftentimes these items are transported in the passenger compartment, which is designed for human passengers and not cargo, by placing the items on passenger seats, or at the feet of the passenger seats. As such, these alternative areas to store and transport the items do not offer much improvement over the truck bed or trunk in terms of securing and safely transporting these sensitive items. Furthermore, sometimes extensive amounts of equipment must be transported within the passenger compartment, making it difficult efficiently organize and use the space in the passenger compartment.

As a result, a vast number of storage systems have been suggested, using as components the common “storage organizers” such as drawers, boxes, bin boxes, hooks, etc., but a need continues to exist for storage systems for the rear compartment of a pickup truck that provide safe, secure, modular, expandable, accessible, storage, which can easily and inexpensively be made to fit the plethora of different types of pickups on the market, and which can be made to fit without requiring that additional mounting holes be drilled in what have become very expensive vehicles.

Thus, there is a need for a well-organized, modular storage system for vehicle, in particular pickup truck owners who have hobbies that require extensive amounts of gear, or professionals that have extensive amounts of gear.

### SUMMARY

Some embodiments provide a modular storage system. The modular storage system can include at least two vertical rails: a first rail and a second rail. One or more adapters can be configured to attach the first rail to one or more mounting points on the rear wall of a vehicle, such as a truck cabin. The adapters attach the rails to the rear wall in a vertical orientation. In particular embodiments, the one or more mounting point is a pre-existing structure for attachment to the frame or body of the vehicle, such as a seatbelt mounting point, or a mounting point for a seat. At least one storage organizer including, but not limited to, things such as drawers or tool organizers, is attached to the rail via an interface piece designed to secure the storage organizer to the rails.

Another set of embodiments provides a method for providing a storage system in a passenger compartment of a vehicle. In various embodiments, the method comprises providing at least two vertical rails having a first rail and a second rail, attaching the at least two vertical rails to one or more mounting point on a rear wall of a vehicle, such as a seatbelt or seat mounting point, so that the at least two vertical rails are in a vertical orientation. The first rail and the second rail are arranged so that they are parallel to each other. The method further comprises attaching at least one storage organizer to at least the first rail at a selected point along the length of at least the first rail.

In another set of embodiments, a passenger compartment for a modular storage system is provided, where the modular storage system is integrated into the rear wall of the vehicle cabin. In various embodiments, the passenger compartment for a modular storage system comprises a rear wall having at least two vertical rails. The at least two vertical rails include a first rail and a second rail parallel to one another and in a vertical orientation. At least one storage organizer is attached to at least one of the at least two rails, and at least one interface piece attaches the at least one storage organizer to the at least one rail.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a perspective view of a truck cabin with a modular storage system, according to various embodiments;

FIG. 2 is a perspective view of two vertical frame rails, adapters and mounting points within a passenger cabin, according to various embodiments;

FIG. 3 is a perspective view of the two vertical frame rails with an attached storage organizer in the form of a drawer, according to various embodiments;

FIG. 4 is a perspective view of the modular storage system having one drawer and one open-ended container mounted to the rails, according to various embodiments;

FIG. 5 is a close-up perspective view of an interface piece coupling a storage organizer to a rail, according to various embodiments; and

FIG. 6 is detail view of a T-shape slotted rail used for mounting a storage organizer, according to various embodiments.

### DETAILED DESCRIPTION OF THE DRAWINGS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention. Furthermore, the terms “passenger compartment” and “cabin,” are used interchangeably throughout the application and should be understood to refer to the area of a vehicle where occupants may or are intended to sit in the vehicle interior.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

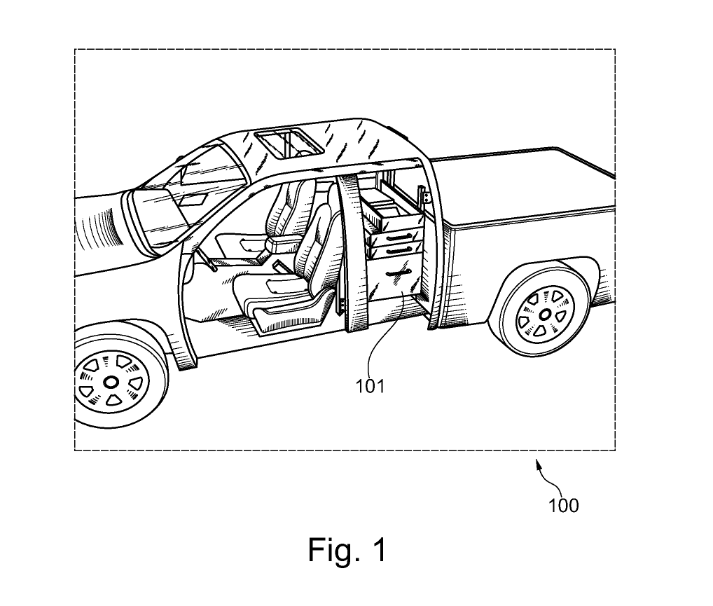

FIG. 1 illustrates a perspective view 100 of the modular storage system 101, according to various embodiments. The modular storage system 101 is implemented in the passenger cabin of a pickup truck and located where the driver side rear passenger seat would normally be located. The modular storage system 101 is oriented such that the storage organizers face outwardly from the driver side passenger door. Thus, in some embodiments, a storage organizer, such as a drawer, can be extended outwardly from the open passenger side door. In some alternate embodiments, the modular storage system might be implemented in the passenger cabin of other types of vehicles including, but not limited to, sedans, vans, minivans, sport utility vehicles, crossover vehicles, hatchbacks, and wagons. In yet other embodiments, the modular storage system might be implemented in some other part of the vehicle, such as on the passenger side of the rear passenger compartment.

Accordingly, a customer can easily configure his own modular storage system 101 dependent on what he wants to store and dependent on the size of the passenger compartment of the vehicle. The modular storage system 101 solves a key problem facing existing storage solutions: the plethora of different types and models of vehicles. Owners of pickup trucks with larger rear compartments, often called crew cabs, can use the available large volume by choosing to mount wider drawers, or other storage organizers, whereas owners of pickups with smaller rear compartments, of called extended cab pickups, can choose narrower drawers, or other storage organizers.

As crew cabs are the most popular type of pickups, a particular application of the invention are drawers that instead of opening out through the rear door—which does not work well on crew cabs as their rear doors open at an angle of less than 90 degrees—open “over” the remaining seat in the rear of the cab. This had the additional benefit of the gear in the drawer being protected from the elements: rain and snow.

In some embodiments, a vehicle manufacturer can incorporate the modular storage system 101 directly into its vehicles. For instance, the modular storage system can be integrated into the rear wall of the cabin, behind the rearmost seats, and can thus offer its customers a storage system that is uniform across a range of different pickup truck sizes and configurations.

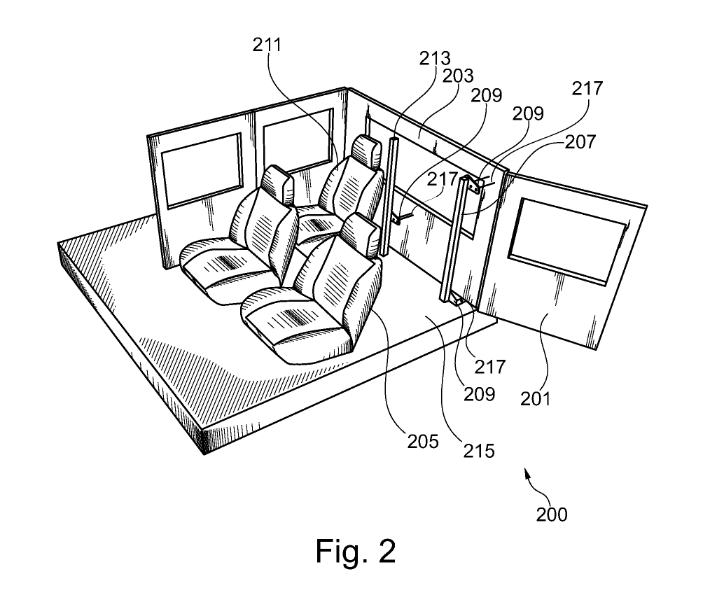

FIG. 2 is a perspective view of a passenger compartment 200, in accordance with a set of embodiments. The passenger compartment 200 has two vertical frame rails 207 and 213. The vertical frame rails are attached to the rear wall 203 via adapters 209. The passenger compartment 200 also includes typical assemblies associated with a vehicle: rear door 201, rear wall 203, driver's seat 205, rear passenger seat 211. The passenger compartment 200 depicts embodiments where 60% of the driver side rear seat has been removed. Modern pickup trucks are typically constructed where a portion of the rear seat assembly, 40%, 60%, or 100%, can be easily removed. A person having ordinary skill in the art will appreciate that the modular storage system is applicable in embodiments where 40%, 60%, or 100% of the rear seat has been removed, as well as embodiments where the rear seat is left in place. In embodiments where the rear seat is left in place, the adapters 209 may share a mounting point 217 with the rear seat. In some embodiments, the adapters are used to attach first rail 207 and second rail 213 substantially parallel to each other along the rear wall 203 of the passenger compartment 200. The adapters are used to mount the first rail 207 and second rail 213 at specific mounting points 217. Mounting points 217 may be, but are not limited to existing attachment points or structures that are normally used to securely attach seatbelts, child safety seats, passenger seats and the like securely to the frame or body of the vehicle. Thus, these mounting points 217 are designed to withstand large forces in the event of a sudden stop and provide a strong and secure attachment of the vertical rails 207 and 213 to the vehicle. Mounting points 217 may be found on the rear wall 203 and/or floor 215 of the vehicle. Accordingly, the modular storage system 101 of FIG. 1 would be implemented behind driver seat 205, where a driver side rear seat would normally be located, and accessible via driver side rear door 201. It will be appreciated that in order to accommodate the many different types of pickup trucks and cabs, only the adapters 209 need to be changed, not the vertical rails 207 and 213 themselves, or the storage organizers. In other embodiments, more rails in addition to vertical rails 207 and 213 might be used. As is noted above, in some embodiments, a vehicle manufacturer could choose to directly incorporate the rails 207 and 213 as part of the vehicle itself, in which case the adapters 209 become unnecessary.

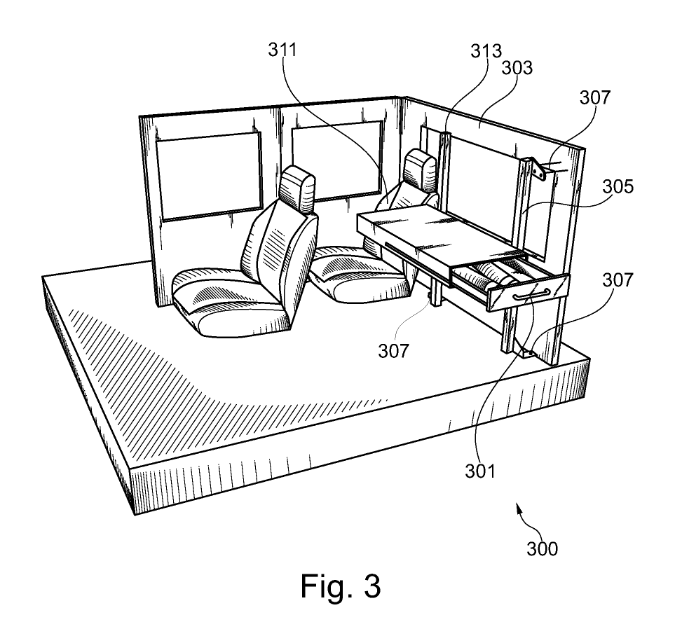

FIG. 3 shows passenger compartment 300 having a storage organizer 301, in the form of a drawer, mounted at an arbitrary height on the vertical rails 305 and 313, next to passenger side rear seat 311. Vertical rails 305 and 313 are attached to mounting points on the rear wall 303 and floor of the cabin via adapters 307. The drawer 301 is rigidly mounted to the vertical rails 305 and 313.

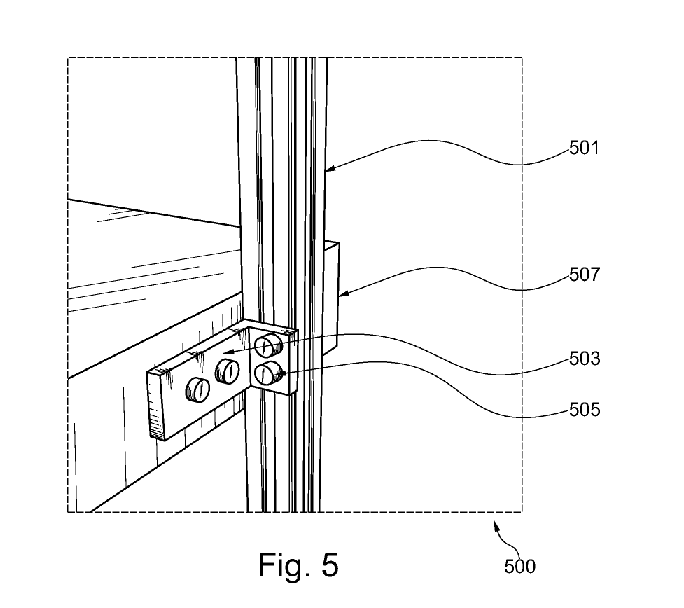

As will be discussed further in FIGS. 5 & 6, slots on the rails 305, 313 allow for a wide variety of storage organizers 301 to be utilized, including, but not limited to: drawers, boxes with lids, open boxes, bins, cases, hooks, rods, baskets, bags, ski carriers, snowboard carriers, gun cases, bike carriers, kayak carriers, fishing rod holders, nets, tool organizers, peg boards, a roof rack, and a horizontal bar for hanging clothing. Different types of storage organizers 301 can be made from many different materials as known in the art for making such storage organizers 301. The storage organizers 301 are mounted at arbitrary heights to the rails 305 and 313, by using the standard distance between the rails, or varying the distance between the rails to accommodate various passenger compartment and also the various storage organizers. In some embodiments, the storage organizer 301 can be slidable and/or movable along the rail after being attached and can be secured at a desired position along the length of the rail.

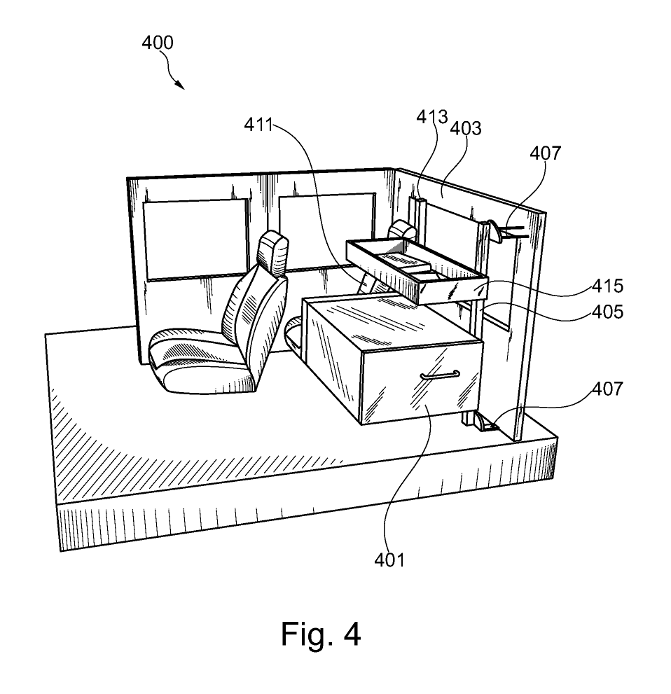

FIG. 4 is an alternative embodiment showing passenger compartment 400 having two storage organizers 401 and 415 mounted to rails 413 and 407 beside passenger side rear seat 411. Vertical rails 405 and 413 are mounted to rear wall 403 via adapters 407. Storage organizers 401 and 415 are of vastly different sizes. For example, storage organizer 401 is both taller and wider than storage organizer 415. Larger storage organizers 401 can be used where the space allows, such as in a crew cab type pickup, whereas the smaller storage organizer 415 can be used where the space may not allow for the larger storage organizer 401, for example in an extended cab pickup truck. In some embodiments, storage organizer 401 may also incorporate adjustable legs, which rest on the floor of the pickup, in order to provide support for heavier contents.

FIG. 5 shows a detail view 500 of how a storage organizer 507 is mounted to the rail 501. An interface piece 503 is bolted to the storage organizer 507 using standard fasteners or may be attached by adhesives, welding or other known connections. The interface piece 503 is in turn mounted to the rail 501 using standard T-slot type hardware 505. T-slot type hardware 505 is well known in the art. By using a slotted rail 501 and standard hardware 505 for slotted rails 501, the storage organizer 507 can now slide along the length of the rail, and once in a desired position, the fasteners 505 can be tightened to secure the storage organizer 507 in place.

Those skilled in the art will appreciate that the slots in the rail 501 can be replaced by a clamp arrangement that would not require a slot. Thus in another set of embodiments, interface piece 503 may simple be a clamp over rail 501, which can be used to secure storage organizer 507 in a desired position by clamping down on rail 501.

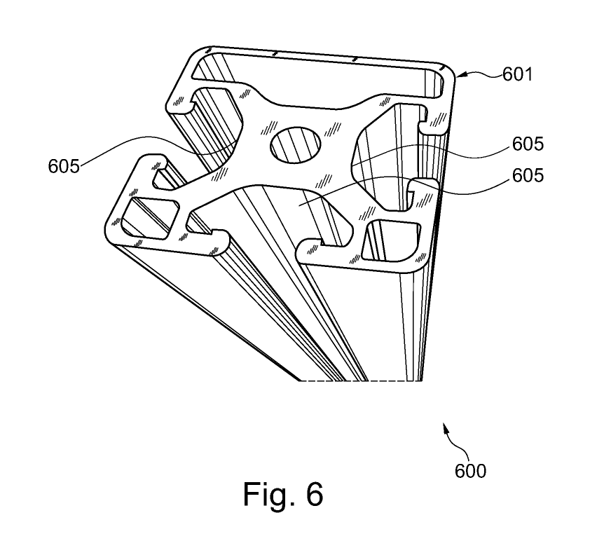

FIG. 6 shows s cross sectional perspective view of a rail 601 according to various embodiments. The cross section of rail 601 shows three T-shaped slots 605. With reference to FIGS. 5 & 6, interface piece 503 would mount to T-shaped slot 605 via T-slot hardware 505. In other embodiments, slot 605 can take various different forms. In some embodiments, slots 605 can take the form of protrusions without changing the nature of the present invention. In other embodiments, the rail 601 may have multiple slots 605 on the same face, thus allowing for a larger numbers of fasteners 505 providing for greater strength of the joint. In various other embodiments, instead of using fasteners 505, the interface piece 503 may take the form of a collar or clamp that can slide along the length of the rail 601, thus eliminating the need for rail 601 to have slots 605. Alternatively, both slots 605 and a clamp arrangement may be used, for example, to more securely attach the clamp to rail 601. Once a storage organizer 507 is placed in the desired position, the interface piece 503 may be used to fix the position of storage organizer 507.

While certain features and aspects have been described with respect to exemplary embodiments, one skilled in the art will recognize that numerous modifications are possible. While certain functionality is ascribed to certain system components, unless the context dictates otherwise, this functionality can be distributed among various other system components in accordance with the several embodiments. Thus, it is to be understood that the one and two storage organizer embodiments are provided by way of example only, and that in other embodiments, modular storage system may have more than two storage organizer, and can support multiple different types of storage organizers.

Structural components described according to a particular design and/or with respect to one type of storage system may be organized in alternative structural designs and/or incorporated within other described storage systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A modular storage system comprising:
at least two vertical rails having a first rail and a second rail;
one or more first adapter configured to attach at least the first rail to one or more mounting point on a rear wall of a vehicle in a vertical orientation, wherein the one or more mounting point is a pre-existing structure for attachment to the frame or body of the vehicle;
at least one storage organizer; and
at least one interface piece attaching the storage organizer to at least one of the at least two vertical rails.

2. The modular storage system of claim 1 further comprising one or more second adapter configured to attach at least the first rail to one or more mounting point on a floor of the vehicle.

3. The modular storage system of claim 1, wherein the first adapter comprises a first connector for attachment to the mounting point on the rear wall of a vehicle and a second connector for attachment to a rail, wherein the first connector and second connector have a fixed distance between them.

4. The modular storage system of claim 1, wherein the first adapter comprises a first connector for attachment to the mounting point on the rear wall of a vehicle and a second connector for attachment to a rail, wherein the first connector and second connector have an adjustable distance between them.

5. The modular storage system of claim 2, wherein each of the one or more second adapter comprises a third connector for attachment to the one or more mounting point on the floor of the vehicle, and a second connector for attachment to a rail, wherein the fourth connector and second connector have a fixed distance between them.

6. The modular storage system of claim 2, wherein each of the one or more second adapter comprises a third connector for attachment to the one or more mounting point on the floor of the vehicle, and a second connector for attachment to a rail, wherein the fourth connector and second connector have an adjustable distance between them.

7. The modular storage system of claim 1, wherein the at least one storage organizer includes drawers, boxes, bins, cases, hooks, rods, baskets, bags, ski carriers, snowboard carriers, gun cases, bike carriers, kayak carriers, fishing rod holders, nets or tool organizers.

8. The modular storage system of claims 1, wherein each of the at least one interface piece is configured to securely attach to at least one of the at least two vertical rails at a user selected point along the length of the at least one of the at least two vertical rails, wherein the at least one storage organizer is attached to the at least one of the at least two vertical rails at the user selected point.

9. The modular storage system of claim 1, wherein the at least two rails contain one or more shaped slots, holes, or protrusions configured to engage with each of the at least one interface piece.

10. The modular storage system of claim 1, wherein each of the at least one interface piece comprises a clamp for attaching to the at least one of the at least two rails by clamping onto the at least one of the at least two rails.

11. The modular storage system of claim 1, wherein the at least one storage organizer is movable along the at least one of the at least two vertical rails, wherein the at least one interface piece is configured to fix the position of the at least one storage organizer along the length of the at least one of the at least two vertical rails.

12. A method for storage in a passenger compartment of a vehicle, the method comprising:
providing at least two vertical rails having a first rail and a second rail;
attaching the at least two vertical rails to one or more mounting point on a rear wall of a vehicle so that the at least two vertical rails are in a vertical orientation, wherein the first rail and the second rail are parallel to each other and wherein the one or more mounting point is a pre-existing structure for attachment to the frame or body of the vehicle;
attaching at least one storage organizer to at least the first rail at a selected point along the length of at least the first rail.

13. The method of claim 12 further comprising attaching the at least two vertical rails to one or more mounting point on a floor of the vehicle.

14. The method of claim 12 further comprising adjusting a distance between the first rail and the rear wall of the vehicle.

15. The method of claim 12 further comprising adjusting a distance between the first rail and the floor of the vehicle.

16. The method of claim 12 further comprising adjusting the selected point along the length of at least the first rail where the at least one storage organizer is attached.

17. A passenger compartment for a vehicle including a modular storage system comprising:
a rear wall having at least two vertical rails, the at least two vertical rails including a first rail and a second rail parallel to one another and in a vertical orientation,
at least one storage organizer attached to at least one of the at least two rails; and
at least one interface piece attaching the at least one storage organizer to the at least one of the at least two vertical rails.

18. The passenger compartment of claim 17, wherein the at least one storage organizer is slidable along the at least one of the at least two vertical rails, wherein the at least one interface piece is configured to fix the at least one storage organizer along a selected length of the at least one of the at least two vertical rails.

19. The passenger compartment of claim 17, wherein the at least two rails contain one or more shaped slots, holes, or protrusions configured to engage with each of the at least one interface piece.

20. The passenger compartment of claim 17, wherein the at least one storage organizer includes drawers, boxes, bins, cases, hooks, rods, baskets, bags, ski carriers, snowboard carriers, gun cases, bike carriers, kayak carriers, fishing rod holders, nets or tool organizers.
